(19) United States
(12) Patent Application Publication
(10) Pub. No.: US 2002/0172236 A1
(43) Pub. Date: Nov. 21, 2002

(54) Fiber laser device and a laser apparatus

(75) Inventors: Hiroshi Sekiguchi, Tokyo (JP); Akiyoshi Tanaka, Tokyo (JP)

Correspondence Address: MORGAN LEWIS & BOCKIUS LLP, 1111 PENNSYLVANIA AVENUE NW, WASHINGTON, DC, 20004, US

(73) Assignee: HOYA CORPORATION

(21) Appl. No.: 10/157,205

(22) Filed: May 30, 2002

Related U.S. Application Data
(62) Division of application No. 09/239,720, filed on Jan. 29, 1999.

(30) Foreign Application Priority Data
Jan. 30, 1998 (JP) P. HEI. 10-18705
Feb. 6, 1998 (JP) P. HEI. 10-25632
Feb. 23, 1998 (JP) P. HEI. 10-40103
Dec. 9, 1998 (JP) P. HEI. 10-350306

(51) Int. Cl. H01S 3/30

(52) U.S. Cl. 372/6

(57) ABSTRACT

A laser fiber 1 is wound around an outer peripheral face 2a of a glass cylindrical member 2 serving as a structural member which can confine excitation lights L₁ and L₂ for exciting the laser fiber 1. The excitation lights L₁ and L₂ from laser diodes 41 and 42 impinge on the vicinity of the outer peripheral end portion of an end face 2b of the glass cylindrical member 2, through prisms 31 and 32, and confined by repeating total reflection at the inner side face of the outer peripheral face 2a. The confined excitation lights are introduced into the laser fiber 1 through portions contacted with the glass cylindrical member 2, thereby causing excitation.

### BACKGROUND OF THE INVENTION

1. Field of the Invention

The present invention relates to a laser device in which excitation light is supplied to a laser active material inside an optical fiber so that laser oscillation or amplification is conducted, and also to a laser apparatus using such a device.

2.Description of the Related Art

In the field of the optical communication or the laser machining, it is requested to develop a laser device which outputs a higher power and is more economical. Conventionally, an optical fiber laser device is known as a laser device having the possibility of satisfying this requirement. In an optical fiber laser device, when the core diameter, the difference between refractive indices of the core and the clad, and the like are adequately selected, the transverse mode of laser oscillation can be set as a single mode in a relatively easy manner. Furthermore, light can be confined in a high density so that interaction between the laser active material and light is enhanced. Since the interaction length can be made larger by prolonging the optical fiber, it is possible to generate at a high efficiency a laser beam which is spatially excellent in quality. Therefore, a laser beam of a high quality can be obtained in a relatively economical manner.

In order to attain a higher output power or a higher efficiency of laser light, excitation light must be efficiently introduced into a region (usually, a core portion) of an optical fiber to which laser activating ions or dyes, or other luminescence centers (hereinafter, referred to as “laser active material”) are added. When the core diameter is set so as to satisfy the single mode waveguide conditions, the diameter is limited to ten and several microns or less. Usually, it is therefore difficult to efficiently introduce excitation light into a core of such a diameter. As means for overcoming this difficulty, a so-called double-clad fiber laser is proposed (for example, see H. Zenmer, U. Willamowski, A. Tunnermann, and, H. Welling, Optics Letters, Vol. 20, No. 6, pp. 578-580, March, 1995).

In a double-clad fiber laser, a first clad portion which is smaller in refractive index than the core portion is formed around the core portion, and a second clad portion having a smaller refractive index is disposed outside the first clad portion. According to this configuration, total reflection due to the difference between refractive indices of the first and second clad portions occurs so that excitation light introduced into the first clad portion propagates while maintaining the state where the light is confined in the first clad portion. During this propagation, the excitation light repeatedly passes through the core portion to excite the laser active material of the core portion. The first clad portion has an area which is larger than that of the core portion by about several hundreds to one thousand times. Therefore, a larger amount of excitation light can be introduced, so that a higher output power is enabled.

A double-clad fiber laser has advantages in that the oscillation efficiency is high, and that the oscillation transverse mode is single and stabilized. When a laser diode (hereinafter, referred to as “LD”) is used, an output power of about several to 10 watts can be obtained. Consequently, it is possible to say that the output power is largely enhanced as compared with a fiber laser of the core excitation type which is previously used.

In the double-clad fiber laser, the excitation is end-face excitation due to one end or both ends of a fiber and hence there are only two places at the maximum through which excitation light can be introduced, thereby producing a problem in that the number of LDs for excitation cannot be increased. In other words, there is no way of increasing the output power of the fiber laser other than the increase of the brightness and output power of the LDs.

On the other hand, an LD array which is currently used for exciting a solid-state laser (including a fiber laser) has a structure in which about 10 to 20 LD chips having a light emission region of about 1 μm×100 μm are laterally arranged so that the whole light emission region has a linear shape of about 1 μm×1 cm and a converging lens converges light generated by the LDs, thereby forming a linear converging light source. This structure is realized by arranging an LD chip in adjacent to another LD chip in the width direction (the direction of the width of 100 μm) of the LD chip along which the converging property is originally inferior. In the state of the art, from the viewpoint of efficient cooling of the LDs, there is no way other than the arrangement of LD chips in the width direction (the direction of the width of 100 μm) of an LD chip. When an LD array is used as an end-face excitation light source for a double-clad fiber laser, therefore, output light of the LD array must be shaped by a prism or a reflecting mirror which has a complex shape, and then converged by a converging lens.

As means for overcoming such a difficulty, a method in which plural double-clad fiber lasers are bundled so as to increase the output power may be intuitionally obvious to those of skilled in the art. According to this method, an average output power may be increased in proportion to the number of bundled fiber lasers. However, the method has a problem in that each core portion is accompanied by a clad portion which is very larger than the core portion (by about 100 times in diameter) and hence the core portions respectively serving as luminescent points are thinly scattered in a space, thereby lowering the brightness. In other words, the method in which plural double-clad fiber lasers are bundled cannot be used in laser machining which requires high convergency, such as cutting or welding.

In place of the above-mentioned end-face excitation, side-face excitation which is widely used by usual solid-state lasers such as a YAG laser may be applied to an optical fiber laser device. In this case, however, there arises the following problem. Since an optical fiber is very thinner than a rod or a slab, most of excitation light is transmitted through the optical fiber, so that the efficiency of the laser is very low.

In such a fiber laser, since the refractive index profile of the clad portion has a step-like shape (the refractive index is constant), a step index difference exists between the clad portion and the portion outside the clad portion. When excitation light impinges on the fiber laser and propagates through the fiber, therefore, the light is easily scattered at the interface between the clad portion and the portion outside the clad portion, with the result that the fiber produces a large loss.

The use of a graded index fiber laser in which, in order to reduce the scattering loss at the interface, the refractive index of the clad portion is continuously reduced as moving toward the outer side may be easily contemplated. For example, the literature by T. Uchida, S. Yoshikawa, K. Washio, R. Tatsumi, K. Tsushima, I. Kitano, K. Koizumi, and Y. Ikeda (Jpn. J. Appl. Phys., Vol. 21, No. 1 (1973) 126) discloses a method in which a laser fiber is placed inside a reflector and excitation is caused by a flash lamp disposed in the periphery, thereby obtaining laser light. This method has drawbacks such as that the laser device is bulky, and that the laser efficiency is low.

### SUMMARY OF THE INVENTION

The invention has been conducted under the above-mentioned circumstances.

It is an object of the invention to provide an optical fiber laser device which, while maintaining advantages of a fiber laser, i.e. excellent convergency, and thermal stability of the output power and the transverse mode, has a high productivity and can be stably used for a long term together with an excitation light source.

It is another object of the invention to provide a laser machining apparatus which uses the optical fiber laser device. It is a further object of the invention to provide an optical fiber laser device in which the efficiency of emitting light can be improved and the laser output power can be remarkably enhanced. It is a still further object of the invention to provide a laser machining apparatus which uses the optical fiber laser device.

A first aspect of the device is a fiber laser device which comprises: an optical fiber which has a core containing a laser active material, and in which laser light is output from an end portion by exciting said active material; an excitation light source which generates excitation light for exciting said laser active material; and a structural member which can confine the excitation light, at least a part of a side face of said optical fiber being contacted with said structural member directly or indirectly via an optical medium, said active material being excited by excitation light incident through the contacted portion.

A second aspect of the device is a fiber laser device according to the first aspect, wherein said structural member has a shape around which said optical fiber can be wound so that the excitation light repeats total reflection at a surface of said structural member and/or a surface of said optical medium contacted with said structural member, and the excitation light is taken out from said structural member to said optical fiber through the portion contacted with the side face of said optical fiber.

A third aspect of the device is a fiber laser device according to the second aspect, wherein said optical fiber is wound around a side face of said structural member having a columnar shape, so that the excitation light incident into said structural member repeats total reflection at the side face of said structural member and/or a surface of said optical medium contacted with the side face, and is absorbed by said active material contained in said core while moving along a spiral optical path around an axis of said structural member.

A fourth aspect of the device is a fiber laser device according to the third aspect, wherein the excitation light is incident on a lower face of said tubular structural member.

A fifth aspect of the device is a fiber laser device according to the third aspect, wherein at least a part of said tubular structural member has a shape in which an area of a section perpendicular to the axis of said structural member is continuously changed along a direction of the axis.

A sixth aspect of the device is a fiber laser device according to the first aspect, wherein the excitation light is incident on said structural member from one selected from: a prism which is closely contacted with the surface of said structural member; a prism which is closely contacted with the surface of said structural member via said optical medium; a groove which is formed directly in the surface of said structural member; a groove which is formed in said optical medium that is closely contacted with the surface of said structural member; a diffraction grating which is disposed on the surface of said structural member; and a diffraction grating which is disposed on said optical medium that is closely contacted with the surface of said structural member.

A seventh aspect of the device is a fiber laser device according to the first aspect, wherein said optical fiber is wound around said structural member, and at least a part of said wound optical fiber is covered by an optical medium having a refractive index which is equal to or larger than a refractive index of said structural member.

An eighth aspect of the device is a fiber laser device according to the first aspect, wherein said optical fiber is wound around said structural member, and at least a part of said wound optical fiber is covered by an optical medium having a refractive index which is smaller than a refractive index of an outermost periphery of said optical fiber.

A ninth aspect of the device is a laser machining apparatus comprising a fiber laser device according to the first aspect, and a converging optical system which converges laser light emitted from said fiber laser device on an object to be machined.

A tenth aspect of the device is a fiber laser device comprising: an optical fiber has a core containing a laser active material, and an outer layer surrounding said core, and in which laser light is output from an end portion of said optical fiber by supplying excitation light to said core, wherein

at least a part of said optical fiber is surrounded by an optical medium so that in a section of said optical medium perpendicular to an optical axis of said optical fiber, plural optical axes of said optical fiber are included within said optical medium, and, in at least a part of a portion surrounded by said optical medium, a refractive index of said outer layer of said optical fiber with respect to excitation light is increased as moving from an outermost portion of said outer layer to an interface between said outer layer and said core, and

excitation light introduced into said optical medium excites, via said optical medium, said active material contained in said core of said optical fiber in said optical medium, thereby generating laser light.

An eleventh aspect of the device is a fiber laser device according to the tenth aspect, wherein said optical fiber is repeatedly folded or wound into a blocky shape, repeatedly folded or wound portions of said optical fiber are closely contacted with each other, or contacted with each other via said optical medium.

A twelfth aspect of the device is a fiber laser device according to the tenth aspect, wherein the refractive index of said outer layer is increased continuously from the outermost portion of said outer layer to the interface between said outer layer and said core.

A thirteenth aspect of the device is a fiber laser device according to the tenth aspect, wherein the refractive index of a center portion of said core is smaller than or equal to a refractive index of an outer peripheral portions of said core.

A fourteenth aspect of the device is a fiber laser device according to the tenth aspect, wherein said optical medium is made of a material totally reflects the excitation light at an outer peripheral face.

A fifteenth aspect of the device is a fiber laser device according to the tenth aspect, wherein said optical medium is made of a material having a refractive index with respect to the excitation light, said refractive index being smaller than or equal to a refractive index of an outermost portion of said outer layer of said optical fiber.

A sixteenth aspect of the device is a laser machining apparatus comprising an optical fiber laser device according to the tenth aspect, and a converging optical system which converges an output of said optical fiber laser device on an object to be machined.

A seventeenth aspect of the device is a fiber laser device of the present invention, which comprises: an optical fiber has a core containing a laser active material; an outer layer that is disposed around said core and that guides excitation light for exciting said laser active material, and in which said laser active material in said core absorbs the excitation light guided by said outer layer, thereby emitting laser light from an end portion of said optical fiber; and at least one excitation light incident port through which excitation light is incident on said outer layer, formed in a side face of said optical fiber so as to prevent the laser light from leaking, and guide the excitation light through said excitation light incident port to excite said laser active material.

An eighteenth aspect of the device is a fiber laser device according to the seventeenth aspect, wherein said excitation light incident port is formed at each of plural places which are arranged along an axial direction of said optical fiber.

A nineteenth aspect of the device is a fiber laser device according to the eighteenth aspect, wherein said excitation light incident ports are arranged at intervals which allow the excitation light incident through said excitation light incident ports to be absorbed by said laser active material in said core of said optical fiber and sufficiently attenuated.

A twentieth aspect of the device is a fiber laser device according to the seventeenth aspect, wherein said optical fiber is wound around a virtual axis, and said excitation light incident port is formed at each turn of said optical fiber so as to be arranged along a direction of said virtual axis.

A twenty first aspect of the device is a fiber laser device according to the twentieth aspect, wherein said optical fiber laser device comprises a semiconductor laser or a semiconductor laser array as an excitation light source, and an optical system which guides an excitation light emitted from said excitation light source, to said excitation light incident ports so that an intensity distribution of said excitation light is in agreement with an arrangement pattern of said excitation light incident ports.

A twenty second aspect of the device is a fiber laser device according to the seventeenth aspect, wherein said excitation light incident port is configured by one of a prism which is closely contacted with a side face of said optical fiber, a diffraction grating which is closely contacted with the side face of said optical fiber, and a groove which is formed in the side face of said optical fiber.

A twenty-third aspect is a laser machining apparatus which comprises an optical fiber laser device according to the seventeenth aspect, and a converging optical system which converges laser light emitted from said optical fiber laser device on an object to be machined.

### BRIEF DESCRIPTION OF THE DRAWINGS

FIG. 1 is a perspective view schematically showing the configuration of a fiber laser device of Embodiment 1 of the invention.

FIG. 2 is an enlarged side view showing the vicinity of a prism 31 in FIG. 1.

FIG. 3 is an enlarged plan view showing the vicinity of the prism 31 in FIG. 1.

FIG. 4 is a view showing three-dimensionally (or in (x, y, z)) a locus of excitation light L₁ which is obtained by computer simulation, in the fiber laser device of Embodiment 1.

FIG. 5 is a view showing the locus of FIG. 4 as seen in the direction of z-axis (the axial direction of a glass cylindrical member 2).

FIG. 6 is a view showing the locus of FIG. 4 as seen in the direction of the side face (in the direction of y-axis).

FIG. 7 is a view showing the locus of FIG. 4 as seen from the side face (in the direction of x-axis).

FIG. 8 is a view showing three-dimensionally (or in (x, y, z)) a locus of the excitation light L₁ which is obtained by computer simulation, in the fiber laser device of Embodiment 1 in the case where θ is set to be 10.

FIG. 9 is a view showing the locus of FIG. 8 as seen in the direction of z-axis (the axial direction of the glass cylindrical member 2).

FIG. 10 is a view showing the locus of FIG. 8 as seen in the direction of the side face (in the direction of y-axis).

FIG. 11 is a view showing three-dimensionally (or in (x, y, z)) a locus of the excitation light L₁ which is obtained by computer simulation, in the fiber laser device of Embodiment 1 in the case where θ is set to be 100.

FIG. 12 is a view showing the locus of FIG. 11 as seen in the direction of z-axis (the axial direction of the glass cylindrical member 2).

FIG. 13 is a view showing the locus of FIG. 11 as seen in the direction of the side face (in the direction of y-axis).

FIG. 14 is a view showing a modification of Embodiment 1.

FIG. 15 is a partial section view schematically showing a fiber laser device of Embodiment 2 of the invention.

FIG. 16 is a perspective view schematically showing a fiber laser device of Embodiment 3 of the invention.

FIG. 17 is a view showing three-dimensionally (or in (x, y, z)) a locus of excitation light L₁ which is obtained by computer simulation, in the fiber laser device of Embodiment 3 in the case where θ is set to be 10°.

FIG. 18 is a view showing the locus of FIG. 17 as seen in the direction of z-axis (the axial direction of a glass cylindrical member 2).

FIG. 19 is a view showing the locus of FIG. 17 as seen in the direction of the side face (in the direction of y-axis).

FIG. 20 is a view showing the locus of FIG. 17 as seen from the side face (in the direction of x-axis).

FIG. 21 is a partial section view schematically showing a fiber laser device of Embodiment 4 of the invention.

FIG. 22 is a view schematically showing a fiber laser device of Embodiment 5 of the invention.

FIG. 23 is a partial section view of the fiber laser device of FIG. 22.

FIG. 24 is a diagram schematically showing an optical fiber laser device of an embodiment of the invention.

FIG. 25 is an enlarged partial section view of the optical fiber laser device of the embodiment of the invention.

FIG. 26 is a view showing the refractive index distribution of the optical fiber laser device of the embodiment of the invention.

FIG. 27 is a diagram schematically showing the guiding state of excitation light in the optical fiber laser device of the embodiment of the invention.

FIG. 28 is a diagram schematically showing an optical fiber laser device of another embodiment of the invention.

FIG. 29 is a perspective view schematically showing an optical fiber laser device of an embodiment of the invention.

FIG. 30 is an enlarged view showing relationships among an excitation light source, a prism, and an optical fiber in the optical fiber laser device of the embodiment.

FIG. 31 is a view similar to FIG. 30 and in an optical fiber laser device of another embodiment of the invention.

### PREFERRED EMBODIMENTS OF THE INVENTION

(Embodiment 1)

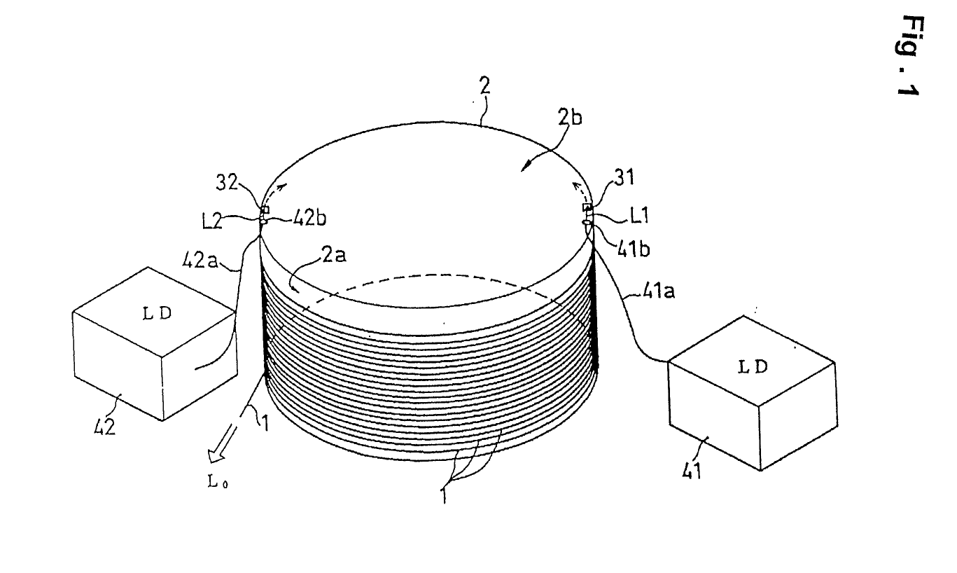

FIG. 1 is a perspective view schematically showing the configuration of a fiber laser device of Embodiment 1 of the invention. In the fiber laser device of the embodiment, as shown in FIG. 1, a laser fiber 1 is wound around the circumferential face 2a of a glass cylindrical member 2. Two excitation light introducing prisms 31 and 32 are attached to end portions of one end face (the upper end face in the figure) 2b in the axial direction of the glass cylindrical member 2. The end portions are in the vicinity of the outer periphery. Two semiconductor laser devices 41 and 42 are disposed which respectively generate excitation lights L₁ and L₂ to be introduced into the glass cylindrical member 2 via the prisms 31 and 32. The excitation lights L₁ and L₂ are guided to the vicinities of the incident faces of the prisms 31 and 32 via optical fibers 41a and 42a which are coupled to the semiconductor laser devices 41 and 42, respectively. The excitation lights L₁ and L₂ are converted into parallel beams by collimator lenses 41b and 42b and then impinge on the prisms 31 and 32, respectively.

The laser fiber 1 has a core diameter of 90 μm, a clad diameter of 1,00 μm, and a length of 50 m. In the laser fiber 1, Nd³⁺ ions are doped at the concentration of 0.5 at. % into the core portion. As the base material of the fiber, phosphate glass (for example, LHG-8 (trademark) of HOYA Corporation) is used. One end of the fiber is flatly polished and then coated with a multilayer film which has a reflective index of 98% or more with respect to a laser oscillation wavelength of 1.06 μm. The other end is coated with a multilayer film which has a reflective index of 10% with respect to a laser oscillation wavelength of 1.06 μm.

The glass cylindrical member 2 is a glass cylindrical member made of Pyrex glass and having a diameter of 10 cm and a length of 5 cm. The end faces and the outer peripheral face are optically polished.

The semiconductor laser devices 41 and 42 are fiber-coupled semiconductor laser devices which have an oscillation wavelength of 0.8 μm and an output power of 15 W. The oscillation laser light is output to the outside via the optical fibers 41a and 42a.

The collimator lenses 41b and 42b are aspherical lenses of a focal length of about 7 mm (for example, IM-A129 (trademark) of HOYA Optics Inc.).

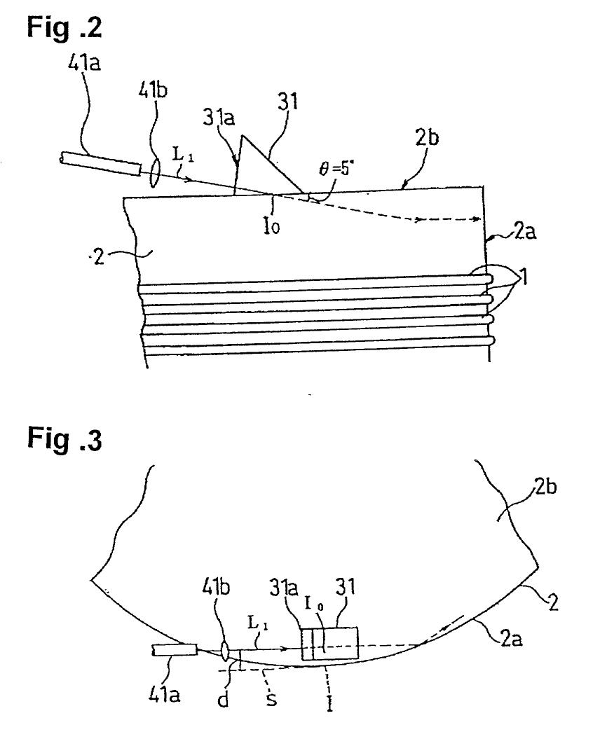

FIG. 2 is an enlarged side view showing the vicinity of the prism 31 in FIG. 1, and FIG. 3 is an enlarged plan view showing the vicinity of the prism 31 in FIG. 1. The vicinity of the prism 32 is configured in the same manner as that of the prism 31. As shown in FIGS. 2 and 3, the prism 31 is a so-called triangular prism. One of the three faces except the side faces which are parallel to each other is used as an incident face 31a. The prism is secured by closely contacting another one face (lower face) with the end face 2b of the glass cylindrical member 2.

The excitation light L₁ emitted from the optical fiber 41a is converted into parallel beams by the collimator lens 41b, impinges on the incident face 31a of the prism 31, and is then introduced into the glass cylindrical member 2 through one point I₀ of the end face 2b of the glass cylindrical member 2. The angle θ formed by the excitation light L₁ incident on the glass cylindrical member 2 and the end face 2b of the glass cylindrical member 2 is set to be about 5°. As shown in FIG. 3, the direction of the excitation light L₁ in a plan view is parallel to a tangential line S at a point I of a contour circle of the end face 2b of the glass cylindrical member 2. At the point I, the line connecting the center of the glass cylindrical member 2 and the point I₀ intersects with the contour circle. The distance d between the excitation light L₁ and the tangential line S is set to be about 1 mm.

The excitation light L₁ incident on the glass cylindrical member 2 reaches the inner side face of the circumferential face 2a, and is totally reflected therefrom by the difference between refractive indices of the glass and the air. The excitation light L₁ which has been totally reflected straightly advances again so as to repeat total reflection from the inner side face of the circumferential face 2a. The excitation light advances in the glass cylindrical member 2 in a downward direction in the figure, while moving in the vicinity of the inner side face of the circumferential face 2a and along a spiral locus, and then reaches the end face (bottom face) which is opposite to the end face 2b. The excitation light is then totally reflected from the end face. Thereafter, the excitation light advances toward the end face 2b along a substantially reverse locus. In this way, the excitation light is confined in the glass cylindrical member 2 while repeating total reflection in the glass cylindrical member 2. The above is applicable also to the excitation light L₂ in a strictly same manner.

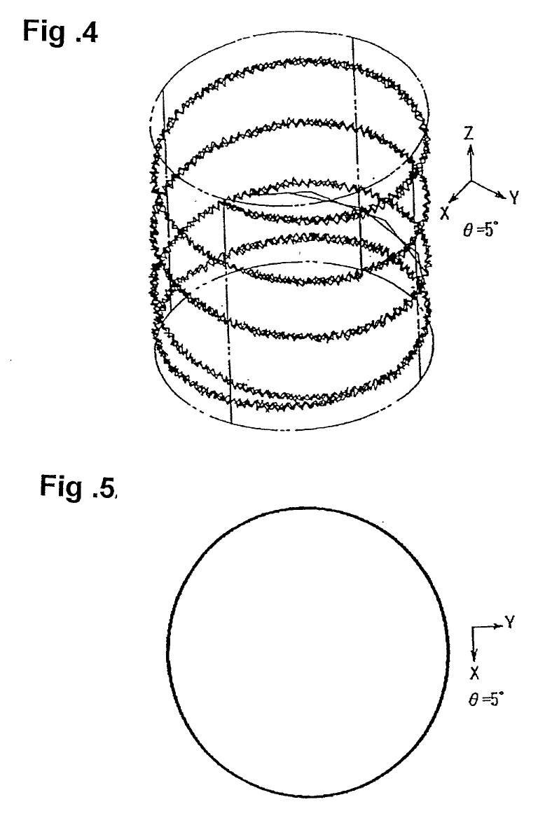

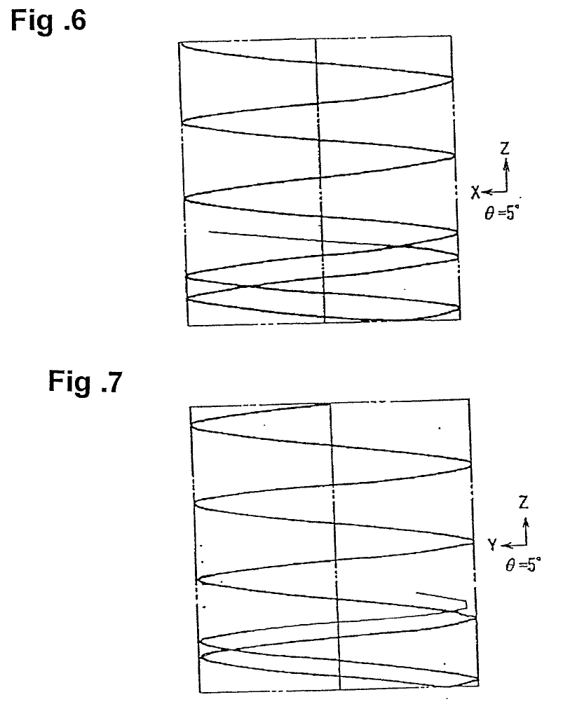

FIG. 4 is a view showing three-dimensionally (or in (x, y, z)) the locus of the excitation light L₁ which is obtained by computer simulation, FIG. 5 is a view showing the locus of FIG. 4 as seen in the direction of z-axis (the axial direction of the glass cylindrical member 2), FIG. 6 is a view showing the locus of FIG. 4 as seen in the direction of the side face (in the direction of y-axis), and FIG. 7 is a view showing the locus of FIG. 4 as seen from the side face (in the direction of x-axis).

The laser fiber 1 is wound around the outer peripheral face 2a of the glass cylindrical member 2. In other words, the clad portion of the laser fiber 1 is closely contacted or, i.e., partially optically coupled with the outer peripheral face 2a. The refractive index of the glass cylindrical member 2 is substantially equal to that of the clad portion of the laser fiber 1. When the excitation light L₁ reaches the contacted part, therefore, the excitation light is introduced into the laser fiber 1 without being totally reflected. Consequently, the excitation light L₁ which has once confined in the glass cylindrical member 2 is introduced at a high efficiency into the laser fiber 1 while circulating in the glass cylindrical member 2.

In the embodiment, laser light L₀ of a wavelength of 1.06 μm was obtained at a high output power of 8 W from the output end of the laser fiber 1.

A converging lens system (focal length: 10 mm) which converges laser light output from the fiber laser device was disposed so as to constitute a laser machining apparatus. As a result, the energy which is 90% or more of the output power was able to be converged into a diameter of 100 μm. In this case, the converging diameter of the output laser beam was stabilized irrespective of the laser output power and the thermal state.

In the fiber laser device of the embodiment, the laser fiber 1 is wound at a large number of turns around the outer peripheral face of the glass cylindrical member 2, and the excitation light is introduced into the glass cylindrical member 2 so as to attain a state where the excitation light is confined in the glass cylindrical member 2 while being repeatedly totally reflected mainly from the inner side face of the outer peripheral face. Therefore, excitation at a very high efficiency is enabled.

Since the excitation light advances in the vicinity of the inner side face of the circumferential face 2a of the glass cylindrical member 2 and along a spiral locus, the confined light beam does not interfere with the light source, the incident port for the light beam, etc. Therefore, a large number of light sources can be used, so that the laser output power can be further enhanced.

The above-mentioned output value of the embodiment is not a limit of the fiber laser device. Since the semiconductor laser array having a small number of laser elements was prepared for excitation, an output power of 8 W only was obtained. It is expected that the upper limit of the laser device is 1 kW or more.

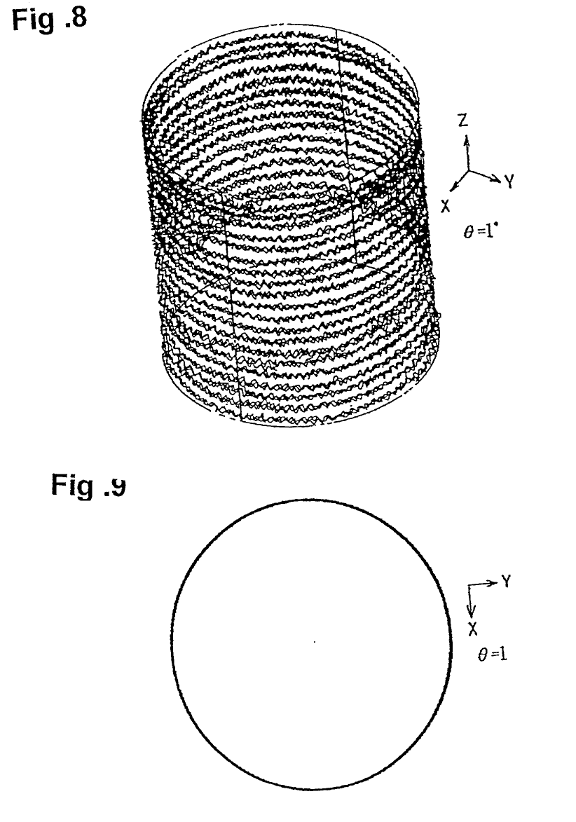

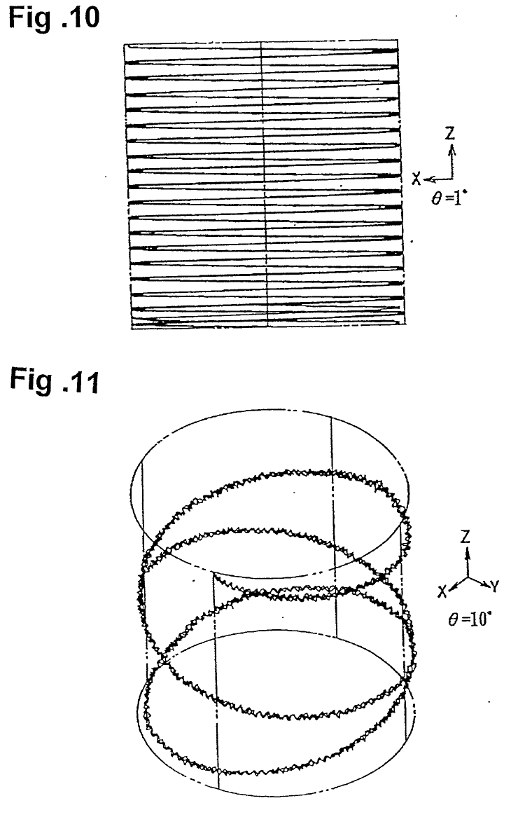

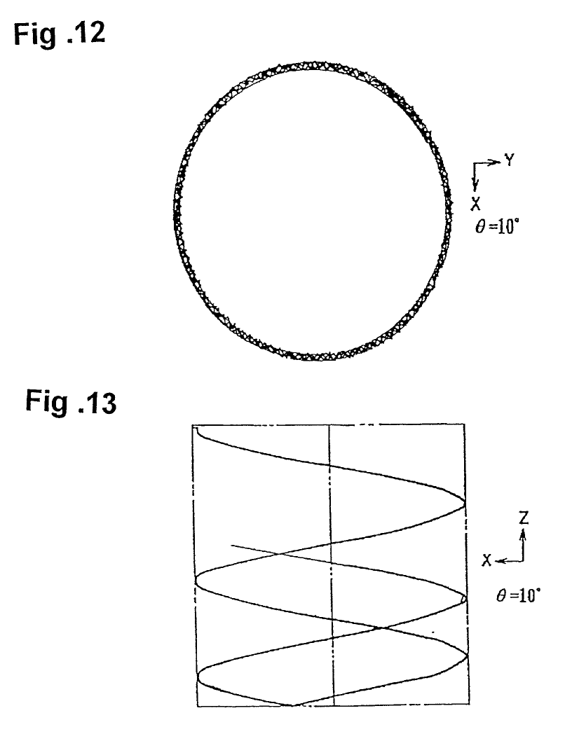

In the embodiment, the angle θ formed by the excitation light L₁ or L₂ and the end face 2b is set to be 5°. The angle may have another value. When θ is set to be a smaller value, for example, the pitch of the spiral becomes small. When θ is set to be a larger value, the pitch of the spiral becomes large. FIGS. 8, 9, and 10 are views showing a locus of the excitation light in the glass cylindrical member 2 in the case where θ is set to be 1°, and FIGS. 11, 12, and 13 are views showing a locus of the excitation light in the glass cylindrical member 2 in the case where θ is set to be 10°. The angle θ may have an appropriate value in accordance with the conditions such as the kind of the laser fiber 1, the material of the glass cylindrical member 2, and the wavelength of the excitation light.

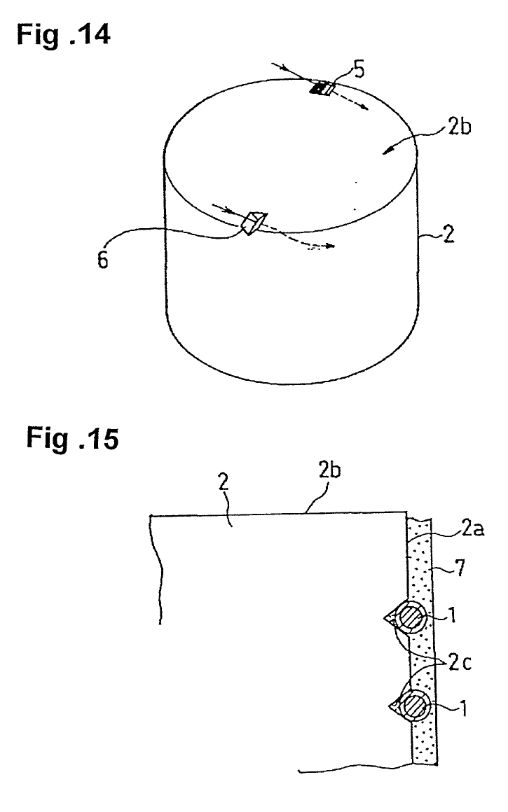

In the embodiment, the excitation light is introduced into the glass cylindrical member 2 via the prisms 31 and 32, so that the loss due to the surface reflection in the introduction is reduced. Alternatively, in place of the prisms 31 and 32, a diffraction grating 5 may be used or a groove 6 may be formed as shown in FIG. 14.

In the embodiment, the laser fiber 1 is wound around the glass cylindrical member 2 in a single layer. Alternatively, the laser fiber may be wound in plural layers.

In the embodiment, the glass cylindrical member is used. The material is not restricted to glass, and any material may be used as far as it is transparent with respect to the excitation light. For example, plastics or the like may be used.

(Embodiment 2)

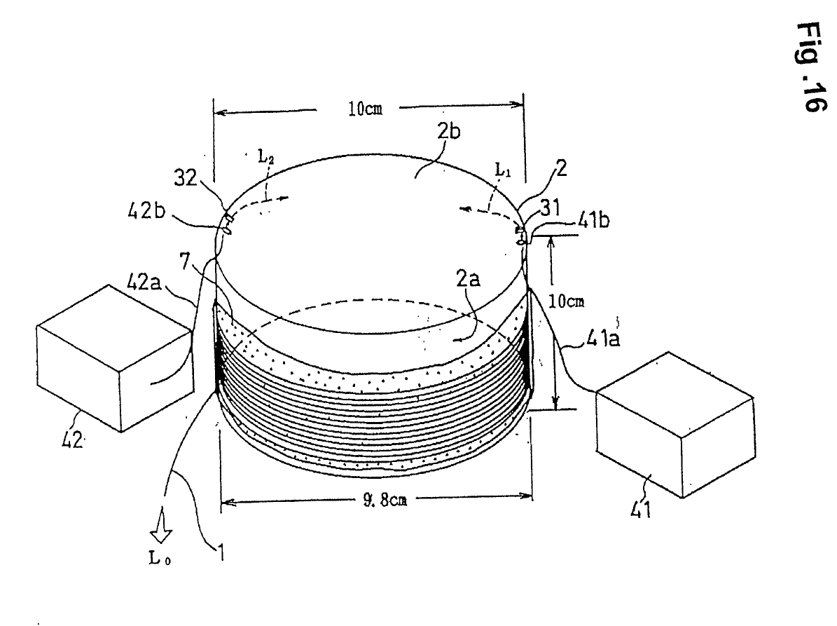

FIG. 15 is a partial section view schematically showing a fiber laser device of Embodiment 2 of the invention. In the embodiment, as shown in FIG. 15, a spiral (screw-like) grooving process is applied at a pitch of 0.2 mm on the outer peripheral face 2a of the glass cylindrical member 2 to form a spiral groove 2c. The laser fiber 1 is wound while being fitted into the spiral groove 2c. A transparent adhesive agent layer 7 is formed on the outer peripheral face 2a so as to cover the wound laser fiber 1. The other configuration is identical with that of Embodiment 1, and hence its detailed description is omitted.

In the embodiment, an excellent result of a laser output power of 9 W at a wavelength of 1.06 μm was obtained. Alternatively, in place of the transparent adhesive agent layer 7, a layer of glass or another resin may be disposed. In the embodiment, the reflective index of transparent adhesive agent layer, glass or other resin layers as an optical medium is preferably equal or nearly equal as that of the glass cylindrical member 2. Further these optical mediums are also used as a member without a spiral groove. Also the embodiment may be modified in the same manner as Embodiment 1.

(Embodiment 3)

FIG. 16 is a perspective view schematically showing the configuration of a fiber laser device of Embodiment 3 of the invention. As the glass cylindrical member 2 in Embodiment 1, a tapered glass cylindrical member is used in which the diameter of the upper end in the figure is 10 cm and that of the lower end is 9.8 cm. The laser fiber 1 is wound around a portion of the glass cylindrical member 2 which portion is in the lower side in the figure. The transparent adhesive agent layer 7 is formed on the outer peripheral face 2a so as to cover the wound laser fiber 1. The other configuration is identical with that of Embodiment 1, and hence its detailed description is omitted.

In the embodiment, since the glass cylindrical member 2 is configured by a tapered glass cylindrical member, the excitation light advances along a locus in which the pitch is smaller as moving more downward in the direction along which the laser fiber 1 is wound.

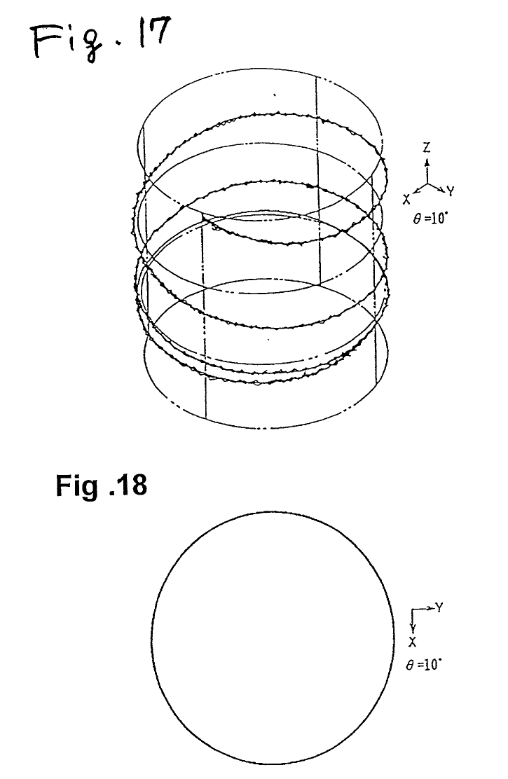

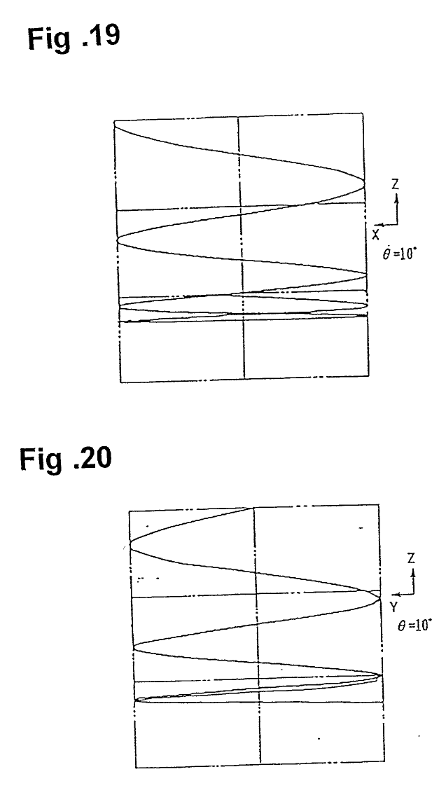

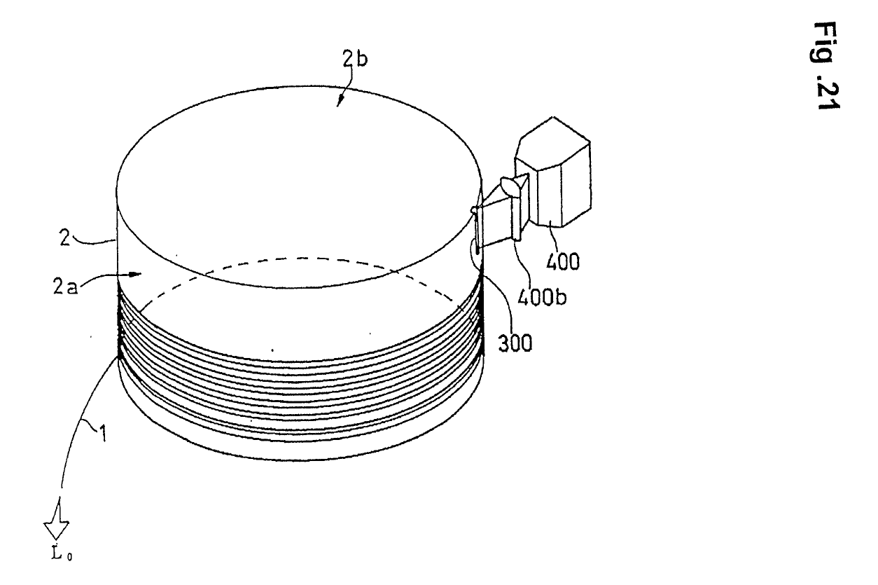

FIG. 17 is a view showing three-dimensionally (or in (x, y, z)) the locus of the excitation light L₁ which is obtained by computer simulation in the case where the angle θ of the fiber laser device of Embodiment 3 is set to be 10°, FIG. 18 is a view showing the locus of FIG. 17 as seen in the direction of z-axis (the axial direction of the glass cylindrical member 2), FIG. 19 is a view showing the locus of FIG. 17 as seen in the direction of the side face (in the direction of y-axis), and FIG. 20 is a view showing the locus of FIG. 17 as seen from the side face (in the direction of x-axis).

When the glass cylindrical member 2 is configured by a tapered glass cylindrical member, the excitation light advances basically along the locus shown in FIG. 17 although the changing state of the pitch of the spiral is varied by varying the angle θ.

In the embodiment, θ was set to be 5°. As a result, the excitation light advances along a locus in which the excitation light once stagnates in the vicinity of a position which is downward separated by 8 cm from the incident face (the end face 2b), and then returns toward the incident face. Therefore, the embodiment attained an effect that the excitation efficiency in the vicinity of the position where the excitation light once stagnates is further enhanced, and an excellent result of a laser output power of 11 W at a wavelength of 1.06 μm was obtained.

A converging lens system (focal length: 10 mm) which converges the laser light output from the fiber laser device was disposed so as to constitute a laser machining apparatus. As a result, the energy which is 90% or more of the output power was able to be converged into a diameter of 200 μm. In this case, the converging diameter of the output laser beam was stabilized irrespective of the laser output power and the thermal state.

In the embodiment, the glass cylindrical member 2 has a simple tapered form in which the diameter is linearly reduced. Alternatively, the glass cylindrical member may have a tapered form in which the diameter is reduced along a curve of a function of higher order, or a form in which the diameter is constant in a range ending at a midpoint and a tapered shape is formed in another range starting from the midpoint.

(Embodiment 4)

FIG. 21 is a view schematically showing the configuration of a fiber laser device of Embodiment 4 of the invention. The embodiment is configured in the same manner as Embodiment 3 except that incidence of the excitation light into the glass cylindrical member 2 is performed through an incident groove 300 formed in the outer peripheral face 2a in place of the end face 2b. Hereinafter, only different portions will be described and description of the identical portions is omitted.

The incident groove 300 is a V-shape groove which is formed in a portion of the outer peripheral face 2a of the glass cylindrical member 2 around which the laser fiber 1 is not wound. The groove has a length of about 10 mm, a width of about 1 mm, and a depth of about 0.7 mm. As a device for generating the excitation light to be incident through the incident groove 300, a semiconductor laser array 400 of an oscillation wavelength of 0.8 μm and an output power of 20 W and having a cylindrical lens 400b was used. In the embodiment, although not illustrated, two incident grooves 300 were disposed and the excitation light was introduced into the glass cylindrical member 2 by using two semiconductor laser arrays 400.

As a result, a relatively excellent result of a laser output power of 6 W at a wavelength of 1.06 μm was obtained. A converging lens system (focal length: 10 mm) which converges the laser light output from the fiber laser device was disposed so as to constitute a laser machining apparatus. As a result, the energy which is 90% or more of the output power was able to be converged into a diameter of 200 μm. In this case, the converging diameter of the output laser light was stabilized irrespective of the laser output power and the thermal state.

(Embodiment 5)

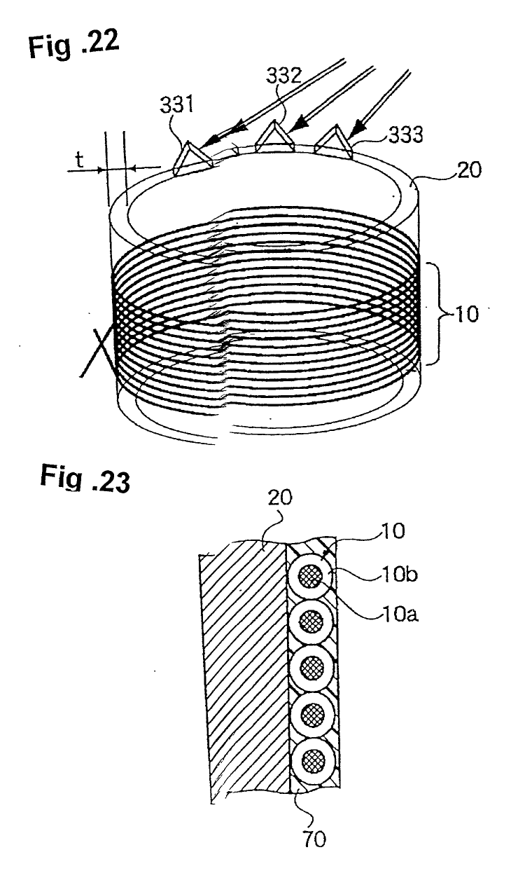

FIG. 22 is a view schematically showing a fiber laser device of Embodiment 5 of the invention, and FIG. 23 is a partial section view of the fiber laser device of FIG. 22. In the embodiment, as shown in the figures, a laser fiber 10 is wound around the outer peripheral face 20a of a glass round pipe 20, and fixed by forming a resin layer 70 on the outer peripheral face 20a so as to cover the laser fiber 10. Three excitation light introducing prisms 331, 332, and 333 are disposed on one end face of the glass round pipe 20, i.e., on the upper end face 20b in an optically close manner. The embodiment is different from the above-described embodiments, mainly in that the glass round pipe 20 is used in place of the glass cylindrical member 2.

The glass round pipe 20 is a round pipe which has an outer diameter of 10 cm, a length of 10 cm, and a thickness t of 1.5 mm, and which is made of quartz glass. The upper and lower end faces of the glass round pipe 20 are formed so as to be parallel with a plane perpendicular to the center axis of the round pipe, and are mirror-polished. The outer peripheral face also is mirror-polished.

In the laser fiber 10 wound around the outer peripheral face 20a of the glass round pipe 20, the diameter of the core portion 10a is 90 μm, that of the clad portion 10b is 125 μm, and the length is 150 m. In the laser fiber, Nd³⁺ ions are doped at the concentration of 0.2 at. % into the core portion 10a. The base material of the fiber is quartz glass. One end face of the laser fiber in the longitudinal direction is flatly polished and then coated with a multilayer film. The end face has a reflective index of 98% or more with respect to a laser oscillation wavelength of 1.06 μm. The other end face is a face which is obtained only by vertically breaking the fiber and has not undergone a coating process or the like. The other end face has a reflective index of about 4% with respect to a laser oscillation wavelength of 1.06 μm.

As the resin layer 70, used is an ultraviolet curing resin (for example, OG125 of EPOXY TECHNOLOGY, Inc. of the U.S.A.) having a refractive index which is similar to that of 1.47 of quartz glass. Alternatively, glass (having a refractive index which is similar to that of the glass round pipe) may be used.

Preferably, the refractive index of an optical material (for example, the resin layer) is equal to that of a structural member (for example, the glass round pipe 20). When an optical material is lower in refractive index than a structural member, the excitation light entering the structural member (the quartz glass) is confined (totally reflected) by the optical medium (the resin layer) (laser fiber) so that the laser fiber is not excited. It is preferable to set the refractive index of an optical member to be equal to or larger than that of the core of the optical fiber. According to this configuration, the excitation light can be efficiently guided to the core.

Although not illustrated, three fiber-coupled semiconductor laser devices which have an oscillation wavelength of 0.8 μm and an output power of 15 W are used as an excitation light generating source which is used for exciting the fiber laser device. A lens is attached to a light emission portion of each of the fiber-coupled semiconductor laser devices. The emission light for excitation is converged into a beam of a diameter of 600 μm. The resulting beams are introduced into the glass round pipe 20 through the above-mentioned excitation light introducing prisms 331, 332, and 333, respectively.

The angle of incidence of each excitation light onto the upper end face 20b of the glass round pipe 20 is about 5°. The direction of each excitation light in the case where the excitation light is projected from the direction of the center axis of the round pipe is substantially parallel to a tangential line to the outer peripheral face at the point where the line connecting the center of the round pipe and the incident point intersects with the outer peripheral face 20a in a plane containing the upper end face.

As a result, a very excellent result of a laser output power of 17 W at a wavelength of 1.06 μm was obtained. This output value is not a limit of the fiber laser device. Since the semiconductor laser devices which were prepared for excitation were small in number, an output power of 17 W only was obtained. When a larger number of semiconductor laser devices are used, a higher output power can be obtained. It is expected that the upper limit of the fiber laser device of the embodiment is 1 kW or more.

The output of the fiber laser device was converged by a lens system of a focal length of 10 mm. As a result, the energy which is 90% or more of the output power was able to be converged into a diameter of 200 μm. The converging diameter of the fiber laser device was always stabilized irrespective of the laser output power and the thermal state.

In the embodiment, since a glass round pipe is used as the structural member for confining the excitation light, the heat radiation property is improved. This is advantageous to a high average output operation. As the glass round pipe is thinner, the heat radiation property is more excellent, and the advantage of the increased excitation efficiency of the laser fiber is further enhanced. In this way, it is preferable to form the structural member for confining the excitation light into a hollow shape having an opening. When a structural member having such a shape is used, the heat radiation property is improved, and hence this is advantageous to a high average output operation. In this case, any hollow shape may be basically employed.

Since, in place of phosphate laser glass, quartz glass was used as the base material of the laser fiber 10, the resistance to laser light is improved. Therefore, the embodiment is advantageous also to a high brightness operation. It is a matter of course that a laser fiber of quartz glass may be used also in Embodiments 1 to 4 in the same manner as this embodiment.

In the embodiment, the system in which the excitation light incident port is configured by attaching a prism is employed. Alternatively, a process of forming a V-groove may be applied on an end face of the glass round pipe or a diffraction grating may be formed. In other words, any kind of an excitation light incident port may be used as far as the excitation light can be incident on it.

As the fiber laser device serving as an excitation light generating source, fiber-coupled devices were used. Alternatively, LD chips or an LD array to which collimator lenses are attached may be used.

In the embodiments described above, a glass cylindrical member or a glass round pipe is used as a structural member in which excitation light can be confined. Any structural member may be used as far as it has a similar function. A semiconductor laser device is used as the excitation light generating source. A laser device of another kind or a light generating device other than a laser device may be used.

As described above in detail, in the above invention, a part of a side face of a laser fiber is contacted directly or indirectly with a structural member in which excitation light for exciting the laser fiber can be confined, and excitation light is introduced into the laser fiber through the contacted portion so as to perform excitation. According to this configuration, excitation light from plural excitation light sources can be confined in the structural member so as to be absorbed into the laser fiber, thereby enabling increase of the output power of a fiber laser device which is difficult to be realized in the prior art.

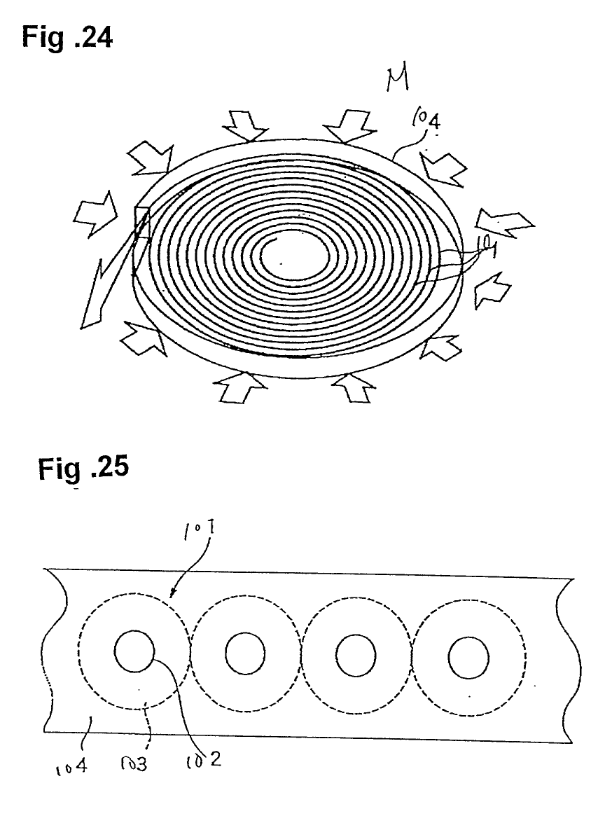

Hereinafter, embodiments of the invention will be described with reference to the accompanying drawings. FIG. 24 schematically shows an optical fiber laser device of an embodiment of the invention, and FIG. 25 shows a section of a part of the device. The optical fiber laser device M of the invention is configured by using an optical fiber 101 having a core 102 containing a laser active material and a clad (outer layer) 103 surrounding the core 102. In the embodiment, the refractive index distribution in the sectional direction is set so that the refractive index is highest in the core 102 to which the laser active material is added and is continuously reduced in the clad 103 surrounding the core as moving toward the outer periphery.

The optical fiber 101 may be produced in one of the following manners. In a first method, a clad structure having a predetermined refractive index distribution is formed in a step of producing a fiber preform by a vapor deposition process such as an inside vapor deposition process (MCVD) or an outside vapor deposition process (OVD or VAD). In this step, when the clad is to be deposited, the addition amount of a compound comprising an element such as fluorine, germanium, or phosphorous which usually causes a change in refractive index and which can be subjected to vapor deposition is continuously changed, thereby forming the clad structure having a predetermined refractive index distribution. Next, the core 102 to which a rear earth element serving as a laser active material is added is formed inside the clad portion. The thus produced fiber preform is heated and drawn. As a result, the optical fiber 101 having a refractive index distribution in which the refractive index of the core portion is high and that of the clad portion surrounding the core is continuously reduced as moving toward the outer periphery is obtained.

In a second method, in a step of producing a fiber preform by the rod-in-tube method, base glass which will be formed as a core layer and to which a laser active material is added is first produced, and a core rod from which a desired core diameter can be obtained is cut out from the base glass. On the other hand, a clad base material having a refractive index which is lower than that of the base glass added with the laser active material is produced, and then formed into a tube-like shape into which the core rod can be inserted. To the inner wall of the tube-like clad glass, an additive which can cause a change in refractive index so that the highest refractive index of the clad inner wall is attained and the refractive index of the clad inner wall is lower than that of the core is added by using the ion exchange process or the like, thereby producing a clad material in which the refractive index in the clad is continuously reduced as moving toward the outside. Next, the core rod is inserted into the clad tube, and the resulting article is heated and drawn. As a result, the optical fiber 101 having a refractive index distribution in which the refractive index of the core portion is high and that of the clad portion surrounding the core is continuously reduced as moving toward the outside of the clad portion is obtained.

Next, the thus produced optical fiber 101 is formed into a blocky shape in an optical medium 104 in a disk-like region as shown in FIG. 24, and then fixed, whereby the optical fiber laser device is completed. Specifically, the periphery of the optical fiber 101 is filled with the optical medium 104 such as a resin or glass which is lower in refractive index than the clad 103, the optical fiber 101 is repeatedly folded or wound in the medium 104 so as to be formed into a disk-like blocky shape, and the optical fiber 101 and the optical medium 104 are fixed, thereby completing the optical fiber laser device of a desired structure.

The periphery of the optical fiber laser device having a disk-like structure is irradiated with excitation light from plural LD light sources. According to this configuration, it is possible to obtain laser light of a desired high output power and a high efficiency. The method of producing the optical fiber 101 is not restricted to the above-described two methods.

(Embodiment 6)

A specific embodiment will be described with reference to FIGS. 25 to 27. In the optical fiber 101 shown in FIG. 25, the clad 103 of 800 μm and having the above-mentioned refractive index portion is disposed in the periphery of the core 102 of a diameter of 10 μm. The optical fiber 101 is wound into a disk-like shape, and hence adjacent portions of the clad 103 are directly contacted with each other. The periphery of the clad 103 is covered by the optical medium 104 of a lower refractive index. When a section of the optical medium 104 with respect to the optical axis of the optical fiber 101 is seen, plural optical axes of the optical fiber 101 are included in the optical medium 104.

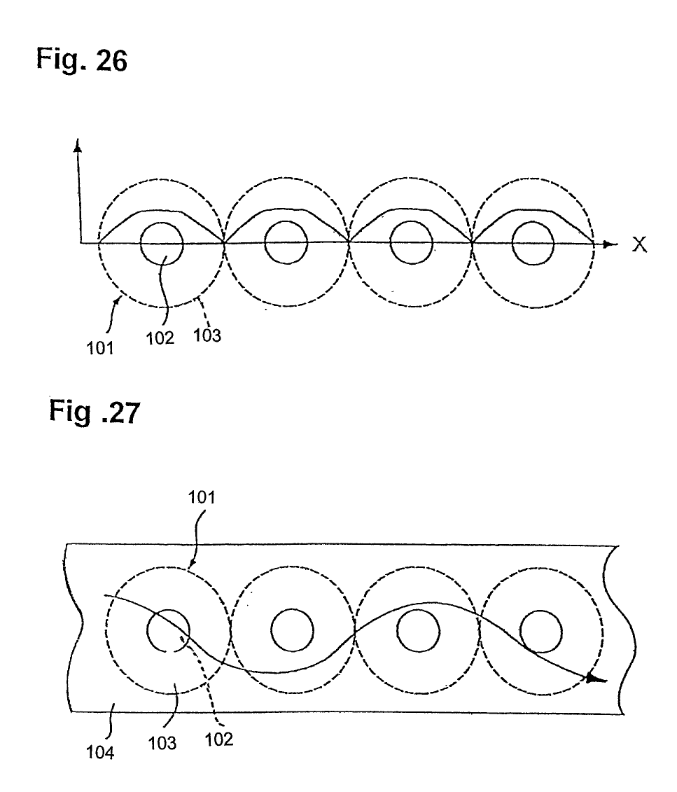

In the core 102 of the optical fiber 101, Nd³⁺ ions are doped at the concentration of 0.5 at. % as a laser active material. In FIG. 25, the periphery of the clad 103 is indicated by a broken line. This shows that the interface of the clad 103 and the optical medium 104 outside the clad is not clear. FIG. 26 shows the refractive index distribution of a center portion of the optical fiber 101. The figure shows the refractive index distribution on the center axis X. In the core 102, the refractive index is high, and, in the clad 103, the refractive index is continuously reduced as moving toward the outside.

FIG. 27 shows the guiding state of the excitation light in the case where the optical fiber laser device was excited by using 16 semiconductor lasers of an oscillation wavelength of 0.8 μm and an output power of 20 W. The excitation light does not repeat discontinuous total reflection at the interface with respect to the clad 103. Unlike a prior art device, therefore, scattering at the interface does not occur. As a result, an excellent result of a laser output power of 120 W at a wavelength of 1.06 μm was obtained in the laser device.

This output value is not a limit of the laser device. Since the semiconductor laser devices which were prepared for excitation were small in number, an output power of 120 W only was obtained. It is expected that the upper limit of the laser device is 2 kW or more.

The output of the laser device was converged by a lens system of a focal length of 50 mm. As a result, the energy which is 90% or more of the output power was able to be converged into a diameter of 50 μm. In a usual YAG laser, the converging diameter is at least 500 μm or more under the same conditions. As compared with such a laser, the converging diameter is 1/10 or less. Since the energy density at a converging portion is inversely proportional to the area of the converging portion, it is possible to generate an energy density which is greater than that of a usual high power YAG laser by 100 times or more. The converging diameter of the laser device is always constant irrespective of the laser output power and the thermal state, and hence the laser machining can be stably performed.

(Embodiment 7)

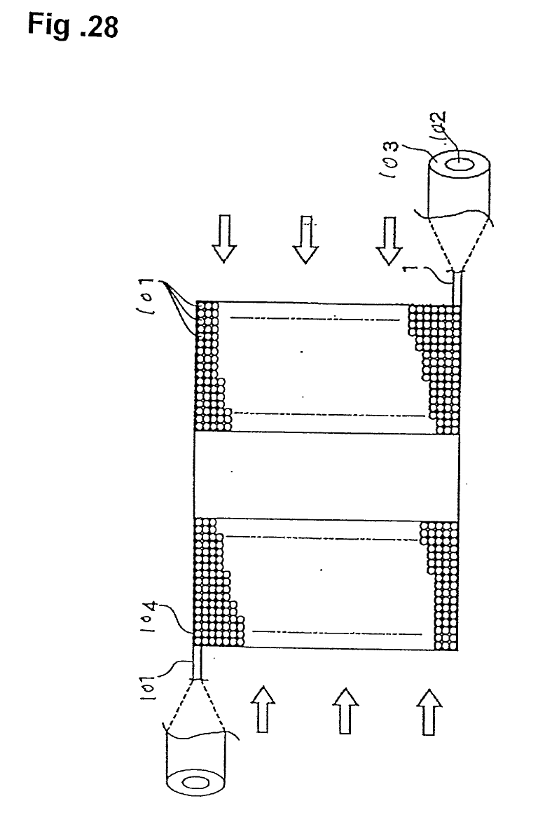

FIG. 28 shows an optical fiber laser device of another embodiment. In the embodiment, the single continuous optical fiber 101 having a refractive index distribution, a core diameter, and a clad diameter which are similar to those of the above-described embodiment is prepared, the optical fiber 101 is wound at a large number of turns so as to form a cylindrical bulk, and the optical fiber is then embedded in the optical medium 104 such as low refractive index glass, thereby producing an optical fiber laser device of a column-like structure.

The laser device was excited from the periphery by using 18 semiconductor lasers of an oscillation wavelength of 0.8 μm and an output power of 20 W in the same manner as Embodiment 6. As a result, laser light of an output power of 140 W at a wavelength of 1.06 μm was obtained from the end portion of the laser fiber 101. The output characteristics of the embodiment are identical with those of Embodiment 6. It is expected that a higher output power can be obtained by increasing the number of semiconductor lasers for excitation. With respect to the convergence diameter, it was confirmed that high convergence was attained and the converging diameter was stabilized irrespective of the thermal state or the like.

As described above, according to the invention set forth in the tenth aspect(for example, the sixth embodiment), a predetermined refractive index change is created in the clad of the optical fiber, and the excitation light is supplied to the core via the optical medium disposed outside the clad, and hence a large amount of excitation light can be introduced into the clad through the side face of the optical fiber. The excitation light which has been once introduced into the optical fiber propagates without causing discontinuous total reflection at the interface between the clad and the optical medium disposed outside the clad. Therefore, the scattering loss at the interface can be reduced. Since the excitation light impinges on plural optical fibers, the intensity of the emission light can be increased in proportion to the number of the optical fibers. As a result, it is possible to obtain a laser of a high output power.

A laser device of the prior art has a structure in which an excitation light source and an optical fiber form a space inside a reflector plate, or that in which excitation light impinges on one end face of an optical fiber. Therefore, such a laser device has a low efficiency and is bulky. By contrast, the laser device of the invention has a structure in which the optical fiber in a closely contacted state is enclosed in the optical medium. Therefore, an excitation light source can be connected to the periphery of the structural member, and a laser device which is small in size and has a high efficiency can be obtained. Furthermore, it is not required to perform end-face excitation, and hence the excitation light source is not damaged by reflection return light. Moreover, the laser active material in the optical fiber can be uniformly excited at a high efficiency without requiring a complex optical system. Consequently, a laser device of a high output power which is produced very easily and miniaturized can be mass-produced without impairing any of the advantages of an optical fiber laser device.

According to the invention set forth in the eleventh aspect(for example, the seventh embodiment), the optical fiber laser device has a structure in which the optical fiber is repeatedly folded or wound into a blocky shape, and the repeatedly folded or wound portions of the optical fiber are closely contacted with each other, or contacted with each other via the optical medium. Therefore, the laser device can be miniaturized while increasing the output power. According to the invention set forth in the twelfth aspect, since the refractive index is continuously changed, no interface exists, so that the scattering loss is reduced and the efficiency is further improved. When all of laser light is converged into a center portion of the core as a result of an increased refractive index of the center portion of the core, the absorption in the center portion becomes large in degree and the loss is increased. When the refractive index is distributed in accordance with the invention set forth in the thirteenth aspect, the absorption loss can be suppressed. According to the invention set forth in the fourteenth aspect, the excitation light is confined in the optical medium, and hence the conversion efficiency is enhanced. According to the invention set forth in the fifteenth aspect, a structure in which the excitation light surely enters the optical fiber is obtained, and therefore the output power can be increased. According to the invention set forth in the sixteenth aspect, it is possible to provide a laser machining apparatus which is small in size and produces a high output power.

(Embodiment 8)

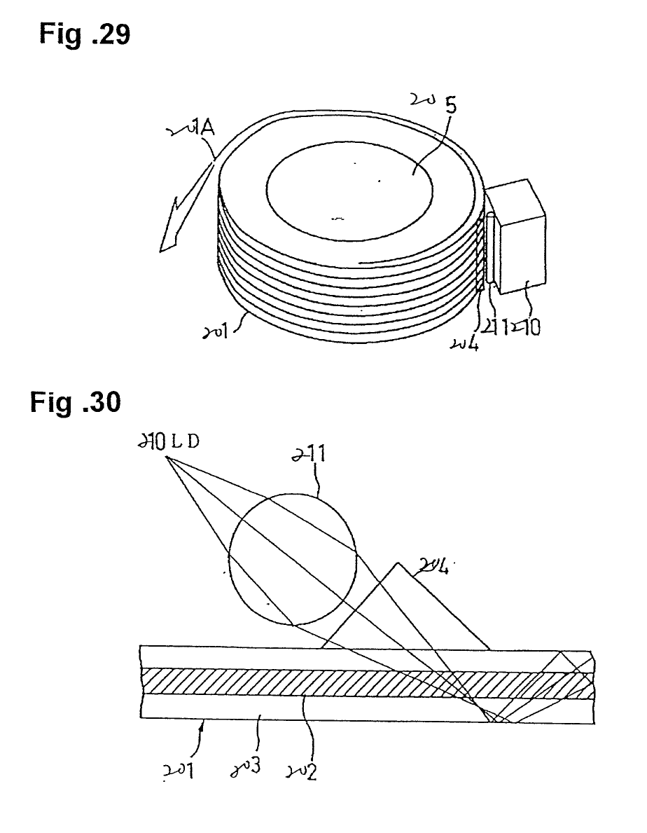

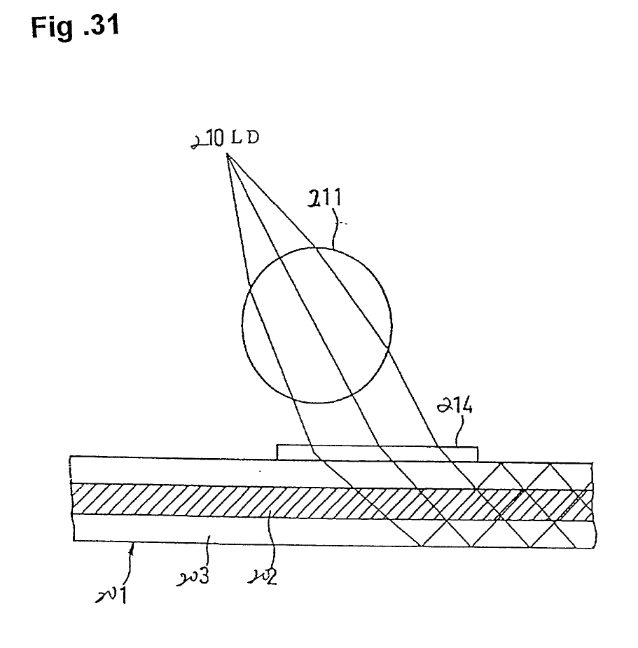

FIG. 29 is a view schematically showing an optical fiber laser device of Embodiment 8 of the invention, and FIG. 30 is an enlarged view of a part of the device. Referring to the figures, 201 denotes a single continuous optical fiber. The optical fiber 201 consists of a core 202 containing a laser active material and a clad (excitation light guiding layer, outer layer) 203 surrounding the outer side of the core. The clad 203 functions to guide excitation light for exciting the laser active material in the core 202. The core 202 has a circular section shape of a diameter of about 90 μm, and the clad 203 has a rectangular section shape in which one side is about 100 μm. Nd⁺³ ions are doped at the concentration of 0.5 wt. % into the core 202. As the base material of the optical fiber 201, phosphate laser glass (LHG-8 of HOYA Corporation) is used. One end of the optical fiber 201 is coated with a multilayer film which has a reflective index of 95% or more with respect to a laser oscillation wavelength of 1.06 μm. The other end is coated with a multilayer film which has a reflective index of 10% with respect to a laser oscillation wavelength of 1.06 μm.

A length of about 30 m of the optical fiber 201 is prepared. The optical fiber is wound in a single or plural layers around the outer periphery of a bobbin (virtual axis) 205 having a diameter of about 10 cm and made of Teflon, and fixed at four places in the circumferential direction by members (not shown) made of Teflon, thereby producing a column-like structural member. The end face which is coated with the multilayer film of a reflective index of 10% is set as the laser output side. A prism 204 serving as an excitation light incident port through which the excitation light enters the inside of the clad 203 is bonded to the side face of the clad 203 of the optical fiber 201 which is positioned in the outermost periphery of the column-like structural member. As an adhesive agent for fixing the prism 204, for example, a photo-setting adhesive agent (Luxtrak LCR0275 (trademark) of TOAGOSEI Co., Ltd.) is used. The prism 204 is a rectangular prism having a triangular section shape of sides of about 1 mm×about 1 mm×about 1.4 mm and a length of 10 mm. The single prism is bonded so that the side of 1.4 mm is opposed to the optical fiber 201 and the length direction is parallel to the axial direction of the column-like structural member. According to this configuration, the excitation light incident port is formed at each turn of the optical fiber 201 so as to be aligned in a line.

Next, in order to allow the excitation light to impinge through the prism 204, an LD array 210 and a cylindrical lens 211 are disposed outside the column-like structural member, thereby constituting the optical fiber laser device of FIG. 29.

In this configuration, excitation light of an oscillation wavelength of 0.8 μm and an output power of 20 W was emitted from the LD array 210, and the excitation light was converged only in the thickness direction of the LD chip by the cylindrical lens 211 of a focal length of 5 mm, and then introduced into the optical fiber 201. As a result, an excellent result that laser light of 5 W at a wavelength of 1.06 μm was output from an end portion 1A of the optical fiber 201 was obtained. It is seemed that this was realized because the prism 204 serving the excitation light incident port was disposed on the side face of the optical fiber 201 and the excitation light was introduced therethrough, and hence the excitation light was able to be introduced into the clad 203 without causing leakage. Moreover, it is seemed that, since end-face excitation is not performed, the degree of freedom in layout of the LD array 210 is increased and the total output power of the excitation light can be easily increased.

Hereinafter, the case where the absorption coefficient of the optical fiber 201 with respect to the excitation light (wavelength: 0.8 μm) is 24 m⁻¹ (a usual value) will be considered. When the clad 203 is excited, the effective absorption coefficient is reduced by a degree corresponding to the area ratio between the core 202 and the clad 203. Specifically, the effective absorption coefficient is as follows:

$$Effective absorption coefficient in the case of excited clad = 24 \times ( core area / clad area ) = 24 \times 0.636 = 16 ( {m}^{- 1} )$$

The optical fiber 201 having such an effective absorption coefficient is wound around the bobbin 205 of a diameter of 10 cm. As a result, the length of one turn is about 31.4 cm, and the attenuation factor (intensity before absorption/intensity after absorption) in the case where the excitation light makes one turn is as follows:

$$\begin{matrix}Attenuation factor = {exp}^{- ( effective absorption coefficient \times length )} \\ = {exp}^{- 5} \\ = 0.66 \%\end{matrix}$$

From the above, it will be seen that most of the excitation light is absorbed as a result of one turn. Namely, the excitation light which has once entered the prism 204 does not exit from the prism 204 after the excitation light makes one turn.

In other words, in the optical fiber laser device, excitation light incident ports are arranged at intervals which allow the excitation light incident through the excitation light incident ports to be absorbed by the laser active material in the core 202 of the optical fiber 201 and sufficiently attenuated. The optical fiber laser device is configured by using the bobbin 205 having a diameter which can realize the intervals. Therefore, the excitation light can be converted into laser light without wasting the energy.

When the excitation light is to be introduced from the LD array 210 into the optical fiber 201 through the prism 204, the cylindrical lens (optical system) 211 functions to guide the excitation light to the excitation light incident ports so that the intensity distribution of excitation light is in agreement with the arrangement pattern of the excitation light incident ports.

In the embodiment, the laser oscillation is performed by using the single LD array 210. Alternatively, plural LD arrays may be used and the number of the arrays is increased in accordance with the length of the optical fiber 201. In the alternative, the output power can be further increased. It is a matter of course that, in place of the LD array, a semiconductor laser may be used as the excitation light source.

(Embodiment 9)

FIG. 31 is an enlarged view of a part of an optical fiber laser device of Embodiment 9 of the invention. In the embodiment, in place of the prism, a diffraction grating 214 is bonded to the side face of the optical fiber 201 so as to constitute excitation light incident ports. The other components are configured in the same manner as those of Embodiment 8, and this embodiment can attain the same effects as those of Embodiment 8.

In place of the diffraction grating, V-grooves may be directly formed in the clad of the optical fiber 201 so as to constitute excitation light incident ports. It is expected that also this configuration can attain the same effects.

When the optical fiber laser device and a converging optical system which converges a laser beam emitted from the optical fiber laser device on an object to be machined are disposed, it is possible to constitute a laser machining apparatus. When the output of the fiber laser device was converged by a lens system (converging optical system) of a focal length of 50 mm, the energy which is 90% or more of the output power was able to be converged into a diameter of 100 μm. The converging diameter is always constant irrespective of the laser output power and the thermal state, and hence the laser machining can be stably performed.

As described above, in the invention, the excitation light incident ports are formed in the side face of the optical fiber, and excitation light from an external light source is introduced into the excitation light guiding layer (clad) through the ports. Therefore, plural LD arrays can be used without using a prism or a reflecting mirror which has a complex shape, and the output power of an optical fiber laser device can be increased while maintaining advantages of the optical fiber laser such as excellent convergency and a high efficiency.

This invention is applicable not only to laser machining apparatus but also to another apparatus such as laser communication apparatus. In this invention, Fiber Laser device represents oscillator, amplifier, combination of oscillator and amplifier, and combination of oscillator or amplifier and other element.

What is claimed is:

1. A fiber laser device comprising:
an optical fiber which has a core containing a laser active material, and in which laser light is output from an end portion by exciting said active material;
an excitation light source which generates excitation light for exciting said laser active material; and
a structural member which can confine the excitation light,
at least a part of a side face of said optical fiber being contacted with said structural member directly or indirectly via an optical medium, said active material being excited by excitation light incident through the contacted portion.

2. The fiber laser device according to claim 1, wherein said structural member has a shape around which said optical fiber can be wound so that the excitation light repeats total reflection at a surface of said structural member and/or a surface of said optical medium contacted with said structural member, and the excitation light is taken out from said structural member to said optical fiber through the portion contacted with the side face of said optical fiber.

3. The fiber laser device according to claim 2, wherein said optical fiber is wound around a side face of said structural member having a columnar shape, so that the excitation light incident into said structural member repeats total reflection at the side face of said structural member and/or a surface of said optical medium contacted with the side face, and is absorbed by said active material contained in said core while moving along a spiral optical path around an axis of said structural member.

4. The fiber laser device according to claim 3, wherein the excitation light is incident on a lower face of said tubular structural member.

5. The fiber laser device according to claim 3, wherein at least a part of said tubular structural member has a shape in which an area of a section perpendicular to the axis of said structural member is continuously changed along a direction of the axis.

6. The fiber laser device according to claim 1, wherein the excitation light is incident on said structural member from one selected from: a prism which is closely contacted with the surface of said structural member; a prism which is closely contacted with the surface of said structural member via said optical medium; a groove which is formed directly in the surface of said structural member; a groove which is formed in said optical medium that is closely contacted with the surface of said structural member; a diffraction grating which is disposed on the surface of said structural member; and a diffraction grating which is disposed on said optical medium that is closely contacted with the surface of said structural member.

7. The fiber laser device according to claim 1, wherein said optical fiber is wound around said structural member, and at least a part of said wound optical fiber is covered by an optical medium having a refractive index which is equal to or larger than a refractive index of said structural member.

8. The fiber laser device according to claim 1, wherein said optical fiber is wound around said structural member, and at least a part of said wound optical fiber is covered by an optical medium having a refractive index which is smaller than a refractive index of an outermost periphery of said optical fiber.

9. A laser machining apparatus comprising a fiber laser device according to claim 1, and a converging optical system which converges laser light emitted from said fiber laser device on an object to be machined.

10. An optical fiber laser device comprising: an optical fiber has a core containing a laser active material, and an outer layer surrounding said core, and in which laser light is output from an end portion of said optical fiber by supplying excitation light to said core, wherein
at least a part of said optical fiber is surrounded by an optical mediumso that in a section of said optical medium perpendicular to an optical axis of said optical fiber, plural optical axes of said optical fiber are included within said optical medium, and, in at least a part of a portion surrounded by said optical medium, a refractive index of said outer layer of said optical fiber with respect to excitation light is increased as moving from an outermost portion of said outer layer to an interface between said outer layer and said core, and
excitation light introduced into said optical medium excites, via said optical medium, said active material contained in said core of said optical fiber in said optical medium, thereby generating laser light.

11. The optical fiber laser device according to claim 10, wherein
said optical fiber is repeatedly folded or wound into a blocky shape, repeatedly folded or wound portions of said optical fiber are closely contacted with each other, or contacted with each other via said optical medium

12. The optical fiber laser device according to claim 10, wherein the refractive index of said outer layer is increased continuously from the outermost portion of said outer layer to the interface between said outer layer and said core.

13. The optical fiber laser device according to claim 10, wherein the refractive index of a center portion of said core is smaller than or equal to a refractive index of an outer peripheral portions of said core.

14. The optical fiber laser device according to claim 10, wherein said optical medium is made of a material totally reflects the excitation light at an outer peripheral face.

15. The optical fiber laser device according to claim 10, wherein said optical medium is made of a material having a refractive index with respect to the excitation light, said refractive index being smaller than or equal to a refractive index of an outermost portion of said outer layer of said optical fiber.

16. The laser machining apparatus comprising an optical fiber laser device according to claim 10, and a converging optical system which converges an output of said optical fiber laser device on an object to be machined.

17. An optical fiber laser device comprising: an optical fiber has a core containing a laser active material;
an outer layer that is disposed around said core and that guides excitation light for exciting said laser active material, and in which said laser active material in said core absorbs the excitation light guided by said outer layer, thereby emitting laser light from an end portion of said optical fiber; and
at least one excitation light incident port through which excitation light is incident on said outer layer, formed in a side face of said optical fiber so as to prevent the laser light from leaking, and guide the excitation light through said excitation light incident port to excite said laser active material.

18. The optical fiber laser device according to claim 17, wherein said excitation light incident port is formed at each of plural places which are arranged along an axial direction of said optical fiber.

19. The optical fiber laser device according to claim 18, wherein said excitation light incident ports are arranged at intervals which allow the excitation light incident through said excitation light incident ports to be absorbed by said laser active material in said core of said optical fiber and sufficiently attenuated.

20. The optical fiber laser device according to claim 17, wherein said optical fiber is wound around a virtual axis, and said excitation light incident port is formed at each turn of said optical fiber so as to be arranged along a direction of said virtual axis.

21. The optical fiber laser device according to claim 20, further comprising:
a semiconductor laser or a semiconductor laser array as an excitation light source; and
an optical system which guides an excitation light emitted from said excitation light source, to said excitation light incident ports so that an intensity distribution of said excitation light is in agreement with an arrangement pattern of said excitation light incident ports.

22. The optical fiber laser device according to claim 17, wherein said excitation light incident port is constituted by one of a prism which is closely contacted with a side face of said optical fiber, a diffraction grating which is closely contacted with the side face of said optical fiber, and a groove which is formed in the side face of said optical fiber.

23. The laser machining apparatus comprising an optical fiber laser device according to claim 17, and a converging optical system which converges laser light emitted from said optical fiber laser device on an object to be machined.
